(19) United States
(12) Patent Application Publication
(10) Pub. No.: US 2010/0189038 A1
(43) Pub. Date: Jul. 29, 2010

(54) CIRCUIT AND METHOD FOR MAPPING DATA SYMBOLS AND REFERENCE SIGNALS FOR COORDINATED MULTI-POINT SYSTEMS

(76) Inventors: Runhua Chen, Dallas, TX (US); Eko N. Onggosanusi, Allen, TX (US); Zukang Shen, Dallas, TX (US); Tarik Muharemovic, Forrest Hills, NY (US)

Correspondence Address: TEXAS INSTRUMENTS INCORPORATED, P O BOX 655474, M/S 3999, DALLAS, TX, 75265, US

(21) Appl. No.: 12/690,412

(22) Filed: Jan. 20, 2010

Related U.S. Application Data
(60) Provisional application No. 61/146,940, filed on Jan. 23, 2009.
(60) Provisional application No. 61/146,945, filed on Jan. 23, 2009.

(51) Int. Cl. H04W 4/00; H04J 3/24

(52) U.S. Cl. 370/328; 370/474

(57) ABSTRACT

A method of mapping data in a wireless communication system is disclosed. The method includes forming a first frame (504) having plural positions at a first transmitter (eNB 1, 200). The first frame has a first plurality of reference signals (500). A second frame (508) has plural positions corresponding to the plural positions of the first frame and is formed at a second transmitter (eNB 2, 450) that is remote from the first transmitter. The second frame has a second plurality of reference signals (506). A plurality of data signals (S1, S2) is inserted into the first frame at positions that are not occupied by either the first or second plurality of reference signals. The plurality of data signals (S1, S2) is inserted into the second frame at positions that are not occupied by either the first or second plurality of reference signals. The first and second frames are transmitted to a remote receiver (UE 1, 106).

This application claims the benefit under 35 U.S.C. §119(e) of Provisional Appl. No. 61/146,940, filed Jan. 23, 2009, and to Provisional Appl. No. 61/146,945, filed Jan. 23, 2009, which are incorporated herein by reference in their entirety.

### BACKGROUND OF THE INVENTION

The present embodiments relate to wireless communication systems and, more particularly, to the mapping of Physical Downlink Shared Channel (PDSCH) data and dedicated reference signals for Coordinated Multiple Point (CoMP) transmission.

With Orthogonal Frequency Division Multiplexing (OFDM), multiple symbols are transmitted on multiple carriers that are spaced apart to provide orthogonality. An OFDM modulator typically takes data symbols into a serial-to-parallel converter, and the output of the serial-to-parallel converter is considered as frequency domain data symbols. The frequency domain tones at either edge of the band may be set to zero and are called guard tones. These guard tones allow the OFDM signal to fit into an appropriate spectral mask. Some of the frequency domain tones are set to values which will be known at the receiver. Among these are Cell-specific Reference Signals (CRS) and Dedicated or Demodulating Reference Signals (DRS). These reference signals are useful for channel estimation at the receiver. In a multi-input multi-output (MIMO) communication system with multiple transmit/receive antennas, cell-specific reference signals are not precoded. This enables a receiver to estimate an unprecoded channel. Demodulation reference signals, however, are precoded to enable a receiver to estimate a precoded channel. An inverse fast Fourier transform (IFFT) converts the frequency domain data symbols into a time domain waveform. The IFFT structure allows the frequency tones to be orthogonal. A cyclic prefix is formed by copying the tail samples from the time domain waveform and appending them to the front of the waveform. The time domain waveform with cyclic prefix is termed an OFDM symbol, and this OFDM symbol may be upconverted to a radio frequency (RF) and transmitted over multiple transmit antennas to provide spatial diversity. An OFDM receiver may recover the timing and carrier frequency and then process the received samples through a fast Fourier transform (FFT). The cyclic prefix may be discarded and after the FFT, frequency domain information is recovered. The reference signals may be recovered to aid in channel estimation so that the data sent on the frequency tones can be recovered.

Conventional cellular communication systems operate in a point-to-point single-cell transmission fashion where a user terminal or equipment (UE) is uniquely connected to and served by a single cellular base station (eNB) at a given time. An example of such a system is the 3GPP Long-Term Evolution (LTE Release-8). Advanced cellular systems are intended to further improve the data rate and performance by adopting multi-point-to-point or coordinated multi-point (CoMP) communication where multiple base stations can cooperatively design the downlink transmission to serve a UE at the same time. An example of such a system is the 3GPP LTE-Advanced system (Release-10 and beyond). This greatly improves received signal strength at the UE by transmitting the same signal to each UE from different base stations (eNB). This is particularly beneficial for cell edge UEs that observe strong interference from neighboring base stations. With CoMP, the interference from adjacent base stations becomes useful signals and, therefore, significantly improves reception quality. Hence, UEs in CoMP communication mode will get much better service if several nearby cells work in cooperation.

Two CoMP schemes (CBS and JP) have been proposed. According to Coordinated Beamforming and Scheduling (CBS), each UE receives PDSCH downlink data from a single transmission point (e.g. base station), but different base stations coordinate with each other to design the downlink transmission to reduce or eliminate inter-cell interference at each UE. According to Joint Processing (JP) each UE receives the same PDSCH downlink data from multiple points.

While the preceding approaches provide steady improvements in wireless communications, the present inventors recognize that still further improvements in downlink (DL) spectral efficiency are possible. Accordingly, the preferred embodiments described below are directed toward these problems as well as improving upon the prior art.

### BRIEF SUMMARY OF THE INVENTION

In a preferred embodiment of the present invention, there is disclosed a method of mapping data in a wireless communication system. The method includes forming a first frame having plural positions at a first transmitter. The first frame has a first plurality of reference signals. A second frame having plural positions corresponding to the plural positions of the first frame is formed at a second transmitter remote from the first transmitter. The second frame has a second plurality of reference signals. A plurality of data signals is inserted into the first frame at positions that are not occupied by either the first or second plurality of reference signals. The plurality of data signals is inserted into the second frame at positions that are not occupied by either the first or second plurality of reference signals. The first and second frames are transmitted to a remote receiver.

### BRIEF DESCRIPTION OF THE SEVERAL VIEWS OF THE DRAWING

FIG. 1 is a diagram of a communication system of the present invention using Coordinated Multiple Point (CoMP) transmission;

FIG. 2 is a simplified block diagram showing uplink (UL) transmission from user equipment (UE) to a base station;

FIG. 3 is a simplified block diagram showing downlink (DL) transmission from a base station to user equipment (UE);

FIG. 4 is a simplified block diagram showing communication between a super-cell comprising multiple base stations (eNB) and user equipment (UE);

FIG. 5A is diagram showing a data mapping according to a first embodiment of the present invention for a subframe having two OFDM control symbols;

FIG. 5B is a diagram showing data mapping according to the first embodiment of the present invention for a subframe having three OFDM control symbols;

FIG. 6A is a diagram showing a data mapping according to a second embodiment of the present invention for a subframe having two OFDM control symbols;

FIG. 6B is a diagram showing data mapping according to the second embodiment of the present invention for a subframe having three OFDM control symbols; and

FIG. 7 is a diagram showing data mapping according to a third embodiment of the present invention for a subframe having Demodulating Reference Signals (DRS).

### DETAILED DESCRIPTION OF THE INVENTION

The preferred embodiments of the present invention provide improved communication through joint processing with distributed transmit diversity. The received signal strength at user equipment (UE) is subsequently improved by receiving the same signal from different base stations (NB) as will be explained in detail.

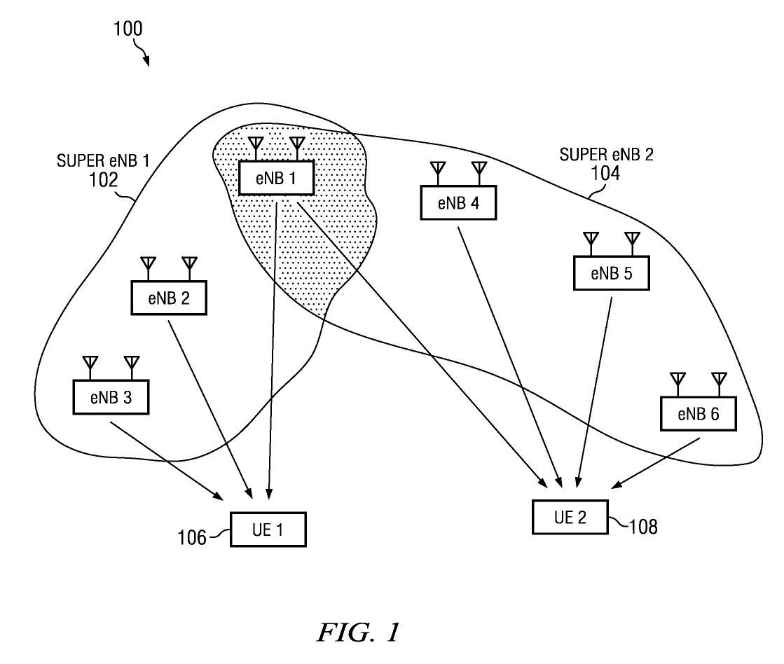

Referring to FIG. 1, there is an exemplary wireless communications system 100 of the present invention. The illustrative communications system includes super-cells 102 and 104. Super-cell 102 is formed by joint processing of evolved base stations eNB 1, eNB 2, and eNB 3 in communication with UE 1 (106). Likewise, super-cell 104 is formed to by joint processing of evolved base stations eNB 1, eNB 4, eNB 5, and eNB 6 in communication with UE 2 (108). Each evolved base station of each super-cell, for example, super-cell 102, jointly processes substantially the same data and transmits it to UE 1 at substantially the same time. In the following discussion, this method of joint processing will be referred to as Coordinated Multiple Point (CoMP) transmission. In this manner, distributed transmit diversity of CoMP from multiple evolved base stations (eNB 1, eNB 2, and eNB 3) greatly improves reception at UE 1 over transmit diversity methods of the prior art.

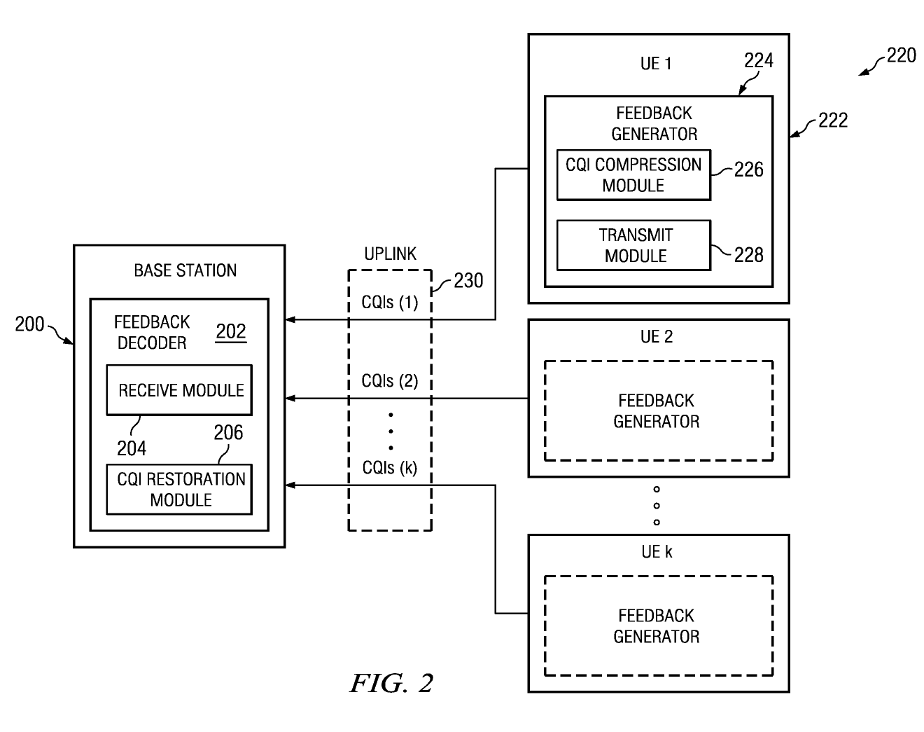

Referring now to FIG. 2, there is a CoMP communication system 220 of the present invention showing uplink transmission. Here and in the following figures, the same reference numerals indicate the same elements. Only one eNB 200 is shown for simplicity. Each UE, for example UE 1 222, receives a downlink transmission from base station 200. Each UE employs reference signals in the downlink transmission to calculate respective channel estimates as well as appropriate channel quality indicators (CQIs). The CQIs may include signal-to-noise ratios (SNR), signal-to-interference plus noise ratios (SINR), bit error ratios (BER), or other appropriate CQIs. Feedback generator 224 receives the calculated CQIs for the respective UE. Respective CQIs are compressed by module 226 and applied to transmit module 228. Transmit module 228 transmits the CQIs over channel 230 to base station 200. Feedback decoder 202 includes receive module 204 and CQI restoration module 206. The receive module 204 receives and demodulates the CQIs. Restoration module 206 decompresses the CQIs so they may be used for subsequent beam forming transmission. Each base station in the super-cell, therefore, may receive different CQIs from a single UE. This advantageously permits each eNB of the super-cell to tailor each subsequent transmission to maximize signal reception at the UE.

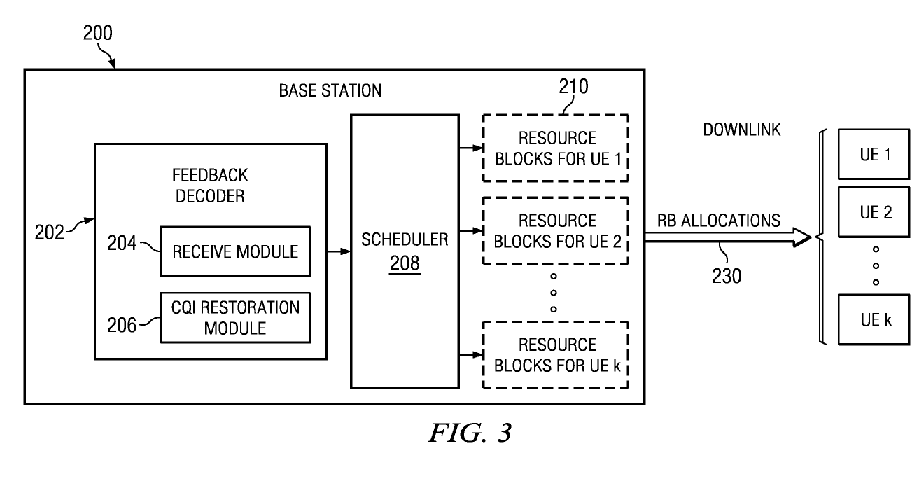

Referring now to FIG. 3, there is a CoMP communication system of the present invention showing downlink transmission. Only one eNB 200 is shown for simplicity. As previously discussed, feedback decoder 202 receives and restores CQIs from each UE. The CQIs are applied to scheduler 208. Scheduler 208 determines the appropriate modulation scheme for the respective CQIs. For example, QPSK may be selected for one CQI while 16 QAM may be selected for a better CQI. Appropriate resource blocks 210 are then allocated for each UE. Here, a resource block is a collection of resource elements (RE), where a resource element is a single tone of one Orthogonal Frequency Division Multiplex (OFDM) symbol. For example, in 3GPP Long-Term Evolution (LTE), a resource block consists of 154 resource elements distributed in 12 adjacent tones over 14 consecutive OFDM symbols in subframe. The allocated resource blocks are then transmitted to respective UEs.

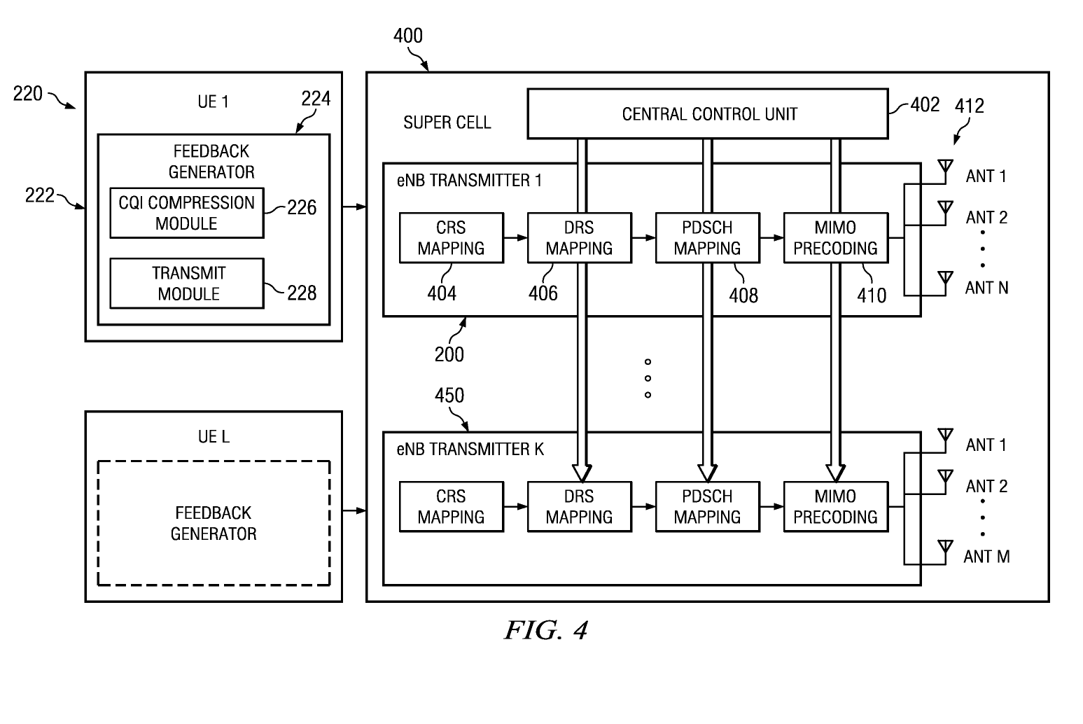

Turning now to FIG. 4, there is a simplified block diagram of a CoMP communication system of the present invention illustrating joint processing. Super-cell 400 includes plural base stations such as 200 and 450. Both base stations are similar, so only base station 200 will be described in detail. Both base stations are controlled by central control unit 402. Central control unit 402 may be remote from both base stations 200 and 450. Alternatively, central control unit 402 may be located with base station 200 which acts as a master control unit for other base stations in the super-cell 400. Base station 200 includes transmitter 1 having a cell-specific reference signal (CRS) mapping module 404, a dedicated or demodulating reference signal (DRS) mapping module 406, a physical downlink shared channel (PDSCH) mapping module 408, a multiple input multiple output (MIMO) precoding module 410, and plural transmit antennas 412. The CRS, DRS, and PDSCH mapping modules construct data subframes for transmission to remote UEs as will be discussed in detail. The time-frequency positions of CRS symbols are cell-specific and can be different in different cells. Similarly, the time-frequency positions of the DRS symbols can be cell-specific and different for different cells. According to the present invention, PDSCH data symbols are preferably mapped to resource elements that are not occupied by either CRS or DRS, For example, if a resource element has already been assigned to transmission of CRS or DRS, it will not be used for PDSCH data, as this is data puncturing. MIMO precoding module 410 precodes both the DRS and PDSCH data with the same precode. The precoded MIMO data and CRS are then transmitted on antennas 412 to remote UEs.

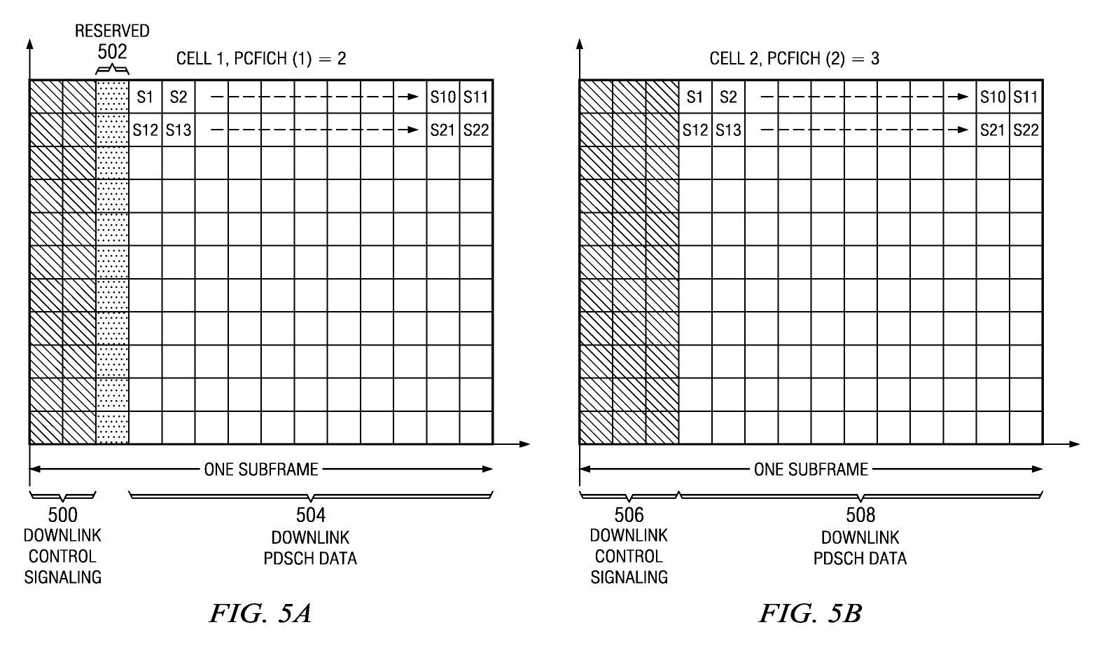

Referring now to FIGS. 5A and 5B, a resource block (12 tones in frequency domain) in 1 subframe (14 OFDM symbols) is shown for downlink transmission from base stations 200 and 450, respectively. It is noted that a fraction of the 14 OFDM symbols are used for transmitting control signals from eNB to UE, while the remaining OFDM symbols are used for transmitting PDSCH data symbols. The OFDM symbols for control transmission are the control region, and the OFDM symbols for data transmission are the data region. For example, in 3GPP LTE the control region size is denoted by the Physical Control Format Indicator Channel (PCFICH) which can be 1, 2, or 3. Furthermore, different cells (base stations) may have different control region size configurations. For example, the resource block of FIG. 5A for eNB 200 includes two OFDM symbols 500 in the control region. In addition, the resource block of FIG. 5A includes reserved symbol 502 and eleven data symbols 504 in the data region. By way of comparison, the resource block of FIG. 5B for eNB 450 includes three OFDM control symbols 506 in the control region and eleven data symbols 508 in the data region. As a consequence, in a conventional cellular system without CoMP, the data and control regions do not overlap within one cell. However, data and control regions in different cells may overlap causing mutual interference.

### CRS Initialization and Mapping

In a first embodiment of the present invention, PDSCH data is mapped to avoid collision with CRS in different CoMP cells. Each CoMP UE knows the Cell ID or cell identification number of all its associated serving cells, so that it may determine the CRS pattern and downlink channel estimation. Here, an anchor cell is a cell to which the UE is synchronized. The Cell ID of the anchor cell is known to the UE by performing downlink synchronization or detecting the Primary Synchronization Signal (PSS) and Secondary Synchronization Signal (SSS). Cell IDs of non-anchor cells is obtained by either synchronizing with them or signaled via a common control channel of the anchor cell.

When the cell-specific reference signals (CRS) are mapped to resource elements, the positions of the CRS in different cells may be different. For example, in LTE Rel-8, a variable frequency domain shift υ_{shift} is applied to the CRS in different cells, where the shift value is associated with the Cell ID as υ_{shift}=N_{ID}^{cell} mod 6. This is purposely designed to randomize cell locations such that frequency domain positions of the CRS in neighboring cells are orthogonal, thereby to reducing interference. After the CRS position is determined by CRS mapping module 404, PDSCH data is mapped to the resource elements not used for reference signal transmission. As a result, the CRS of one cell may collide with PDSCH data of another cell if PDSCH data mapping is not performed properly. Although this may be acceptable for non-CoMP single-cell transmission, it will produce interference in PDSCH data and degrade downlink spectral efficiency for CoMP joint processing.

To resolve this problem, the present invention defines several PDSCH data mapping rules. In one embodiment of the present invention, PDSCH mapping for CoMP joint processing follows the same mapping rule as in non-CoMP single-cell transmission. Hence, the mapping of PDSCH data in each cell is performed independently without considering possible CRS and PDSCH data collisions. In another embodiment, PDSCH data symbols are mapped to a RE only if this RE does not collide with any CRS in any cell in the CoMP super-cell. Thus, CRS resources in all cells are reserved, and PDSCH data is mapped only to the remaining resource elements. In yet another embodiment, PDSCH data mapping in a reference cell (e.g. anchor cell) follows the same mapping as in the reference cell. In this case, PDSCH data colliding with CRS in a non-reference cell is punctured. In a final embodiment, PDSCH data is mapped to Region I and Region II separately. Region I corresponds to PDSCH REs that do not collide with any CRS in any cells of the super-cell. PDSCH data is mapped to this region first. For every cell k, Region II includes the REs that collide with a CRS from at least one cell in the CoMP super-cell other than cell k. PDSCH mapping in Region II is similar to non-CoMP single cell mapping with all REs in Region I being reserved.

In this last embodiment, the network configures cells into a CoMP super-cell only if their CRS positions are exactly the same in the time-frequency domain (e.g. cell IDs are equivalent modulo 6, υ_{shift}=N_{ID}^{cell(1)} mod 6=N_{ID}^{cell(2)} mod 6= . . . N_{ID}^{cell(M)} mod 6). PDSCH in all cells follow the same mapping rule as in a non-CoMP single-cell manner.

### Unequal Region for Downlink Control Channels in Different Serving Cells

In conventional non-CoMP system such as LTE Rel-8, the control region size is a cell-specific value denoting the number of OFDM symbols (OS) per subframe for downlink control signal transmission. This is denoted by PCFICH (Physical Control Format Indicator Channel) and takes value PCFICH=1, 2, 3, in LTE Rel-8. It is also noted that the control region size (PCFICH) can be different in different cells. For example, the subframe structure of two cells (cell-1 and cell-2) is given in FIGS. 5A and 5B. Cell-1 assigns two OSs to the downlink control channels (FIG. 5A), while cell-2 assigns three OSs to downlink control channel (FIG. 5B). Hence, the third OS in cell-1 will transmit PDSCH data, and the third symbol in cell-2 will transmit control signals. In other words, the third OS in cell-1 and cell-2 can not transmit the same contents. There are 12 OSs available for PDSCH in cell-1, but only 11 OSs for cell-2.

For CoMP joint processing, it is preferable such that a UE knows the PCFICH values of all of its serving cells (e.g., PCFICH(1), PCFICH(2), . . . PCFICH(M), M being super-cell size). This can be done by decoding of different cells' PCFICH values independently. Alternatively, a reference cell may signal in its downlink control channel the PCFICHs of other non-reference cells (e.g., reference cell is the anchor cell). This is feasible unless fast PCFICH information exchange between serving cells is considered a problem due to X2-backhaul capacity and delay.

In order to achieve the most cooperative macro diversity gain with coherent/non-coherent combining, it is desirable to always allocate the PDSCH data symbol the same RE in different serving cells, As a result, when different cells in the CoMP super-cell have different control region size, the following PDSCH data mapping rules are proposed for CoMP joint processing.

In one embodiment, PDSCH data mapping in all serving cells assume a common control region size of

PCFICH_{COMMON}=max_{k=1, 2, . . . M}{PCFICHₖ}

Then a mapping rule as in non-CoMP system is performed based on this nominal control region PCFICH_{COMMON}. In other words, data is only mapped to PDSCH regions that are commonly available to all serving cells and will not collide with the control region of any cell in the super-cell, following the mapping rule of non-CoMP single-cell fashion. On the other hand, regions in cells with control region PCFICH(k)<PCFICH_{COMMON} are reserved and not used for PDSCH data transmission. For example, consider a super-cell with two cells, cell-1 (200) and cell-2 (450). Cell-1 has a control region size PCFICH(1)=2 OFDM symbols depicted in FIG. 5A, and cell-2 has a control region size PCFICH(2)=3 OFDM symbols depicted in FIG. 5B. For PDSCH data mapping, only the last 11 OFDM symbols are used to map the PDSCH data, i.e. region 504 in FIG. 5A and region 508 in FIG. 5B. The third OFDM symbol 502 in cell-1 (FIG. 5A) is reserved and not for PDSCH data mapping, because it will collide with the control region of cell-2. This advantageously avoids the collision of PDSCH data and control symbols for different cells in the super-cell.

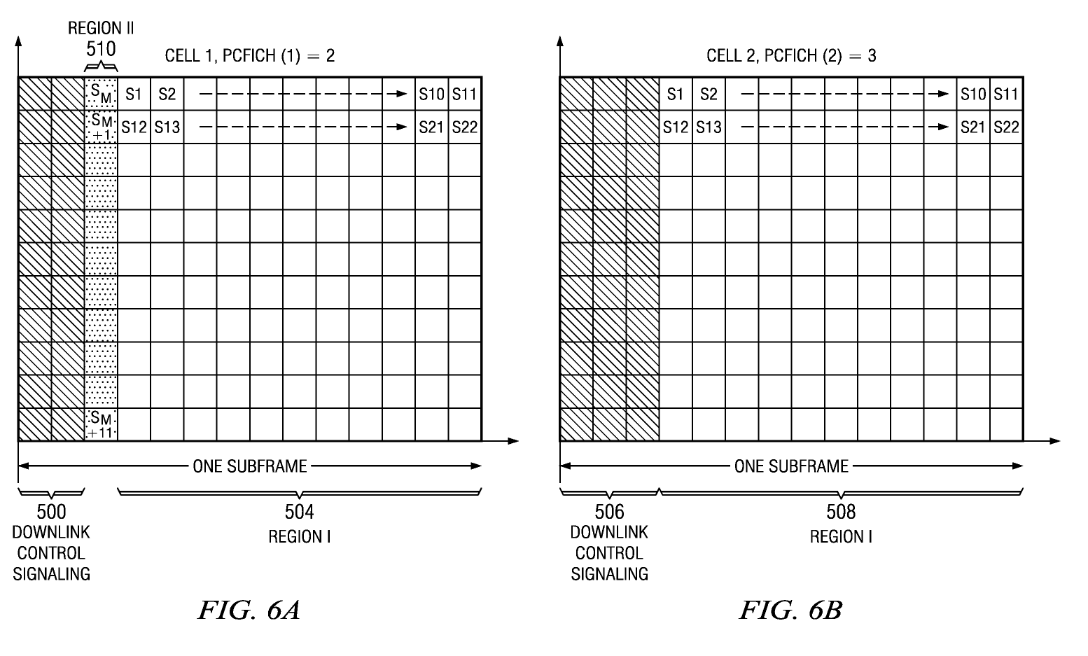

In another embodiment, PDSCH data mapping is performed in two steps, depicted in FIGS. 6A and 6B.
In a first step, the PDSCH data mapping is performed in Region I—“common PDSCH region” of all serving cells assuming a common control region size of

PCFICH_{COMMON}=max_{k=1, 2, . . . , M}{PCFICHₖ}
where the same mapping rule as in non-CoMP single-cell manner is performed. For instance, the common PDSCH data symbols are mapped into regions 504 and 508 of FIGS. 6A and 6B, respectively
In a second step, for cells with PCFICH(k)<PCFICH_{COMMON}, e.g. cell-1 (eNB 200) in FIG. 6A, the remaining PDSCH data is mapping to the remaining resource elements—Region-II which contains PCFICH_{COMMON}−PCFICH(k) OFDM symbols, for instance in the 3^{rd} OFDM symbol 510 in FIG. 6A. This more efficiently uses the resource elements in cell-1 (eNB 200) not used for control symbol transmission and will subsequently improve the spectral efficiency.

In yet another embodiment of the present invention, the network central control unit 402 will only combine base stations having a same size control region in their respective subframes to enter a CoMP super-cell. For example, the network central control unit 402 will configure two cells (eNB 200 and 405) to have the same control region size of 2 OFDM symbols. Hence, the control region and data region of two cells in the super-cell are equivalent, Thus, the PDSCH data mapping can follow the non-CoMP single-cell PDSCH data mapping, without creating any collision of control and data belonging to different cells.

### DRS Initialization and Mapping

In the following, the sequence initialization and mapping to the resource elements in the time-frequency domain is discussed for DRS symbols in CoMP joint processing.

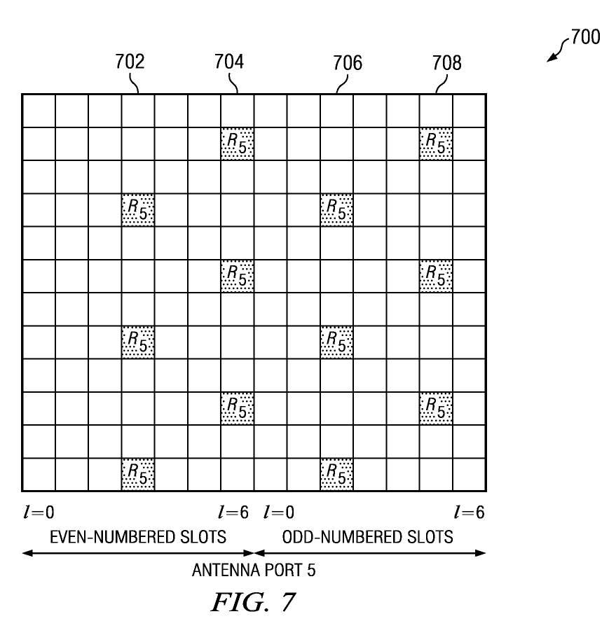

Turning now to FIG. 7, subframe 700 includes 14 OFDM symbols in columns and 12 rows of tones. The subframe also includes DRS (R₅) in OFDM symbols 702, 704, 706, and 708. DRS symbols are reference signals embedded in the downlink transmission and are precoded with the same precoding matrices as for PDSCH data. Hence, DRS enables user terminal to estimate the effective precoded downlink channel for demodulation. The DRS are added to the subframe by DRS mapping module 406 (FIG. 4) prior to transmission. The precoding vector/matrix applied on different cells (e.g., eNB, cell sites, remote radio head) in a CoMP super-cell could be different. Upon channel estimation UE observes a composite channel as if the transmission is from a single point, although the physical wireless signal (PDSCH and DRS) are essentially a composite of signals from multiple cells. For example, if the channel from the first cell is H1 and the channel from the second cell is H2, the channel experienced by the UE is effectively H=H1+H2, achieving a macro diversity gain beneficial for both capacity and error performance improvements.

The first issue associated with DRS for CoMP joint processing is regarding the initialization of DRS sequence in different cells within a super-cell. For conventional single-cell non-CoMP system, the DRS sequence is initialized as a pseudo-random sequence known to both the base station and the served user terminal. For instance in LTE Rel-8, a pseudo random sequence generator is initialized with the Cell-ID and UE-ID, which are available to both the base station and the UE. Hence, the UE understands the DRS sequence to estimate the effective precoded downlink channel.

For CoMP joint processing where a UE receives the same PDSCH data transmission from multiple cells or base-stations, a problem arises when different cells have different cell-IDs, as a result of which different DRS sequences might be sent from different cells. This will substantially degrade the channel estimation accuracy and spectral efficiency at UE.

According to the present invention, the same DRS sequence is applied on different cells involved in CoMP super-cell to a UE configured on CoMP mode. This can be done by configuring the pseudo-random number generator of each eNB of the super-cell targeting a specific UE to be initialized by the same code. This initialization code is preferably a function of the super-cell identification code and one of the UE identification codes within the super-cell. Alternatively, the initialization code may be a function of the super-cell identification code and an arbitrary identification code communicated to the UEs within the super-cell. For instance, the DRS sequence in all eNBs (cells) can be initialized based on a nominal Cell-ID and nominal UE-ID, which is commonly known and used to generate the DRS sequence transmitted from all cells in the CoMP super-cell. The nominal cell-ID and UE-ID can be configured by higher-layer signaling semi-statically. As another example, the CoMP super-cell may configure the nominal Cell-ID and UE-ID to be equivalent to the Cell-ID and UE-ID associated with the first cell.

### DRS Mapping in Different Cells

The second issue associated with DRS for CoMP joint transmission is regarding the DRS position in the time and frequency domain. In conventional non-CoMP single-cell transmission, the time-frequency position of DRS in different cells is not fixed but variant depending on the cell. For example in 3GPP LTE Rel-8, the DRS is shifted in the frequency domain by a cell-specific shift value specified by the Cell-ID (υ_{shift}=N_{ID}^{cell} mod 3). This is purposely designed to randomize the DRS position and to avoid constant collision of DRS in different cells. However, in a CoMP system where a UE receives data transmission from multiple cells, the UE must utilize the DRS of all cells to estimate the downlink channel. Hence, DRS position of different cells must be jointly designed.

According to the present invention, there are two methods to map the DRS in different cells in CoMP joint processing. In a first method, it is desirable to map the DRS of different cells on exactly the same resource elements to facilitate channel estimation. In other words, the DRS in different cells will be located in the same time-frequency position in different cells. This enables the UE to use the DRS to estimate the composite effective downlink channel H=H₁+H₂+ . . . H_{M}, where Hₖ is the channel associated with the k-th cell. In a second method, the DRS of different cells are mapped in completely non-overlapping resource elements, such that DRS in different cells are orthogonal and not interfering with each other. In this case, the UE can estimate the channel associated with different cells (Hₖ) separately due to the collision-free property of DRS, and thus derive the effective composite downlink channel. More details are provided in the following.

In one of the embodiments, PDSCH is mapped to resource elements that do not collide with DRS in any cell in the CoMP super-cell. In other words, if a resource element is occupied by a DRS symbol in any cell in the super-cell, PDSCH should be punctured on this resource element in all cells in the super-cell. Additionally, the central network control unit 402 is to further restrict the super-cell such that the DRS symbols in every cell are orthogonal in time-frequency domain. For instance for a LTE system, this is done by configuring the DRS frequency shift in different cells to be different. As a result, DRS in different cells will be completely orthogonal and the UE can estimate each cell's channel Hₖ (k=1, 2 . . . M). independently. The composite channel seen by the UE is therefore derived as H=H₁+H₂+ . . . H_{M}.

In another embodiment, the network central control unit 402 preferably configures the DRS in different cells to be mapped to the same time-frequency position. For instance, the network can configure the DRS frequency shift to be identical in different cells. As a consequence, DRS in different cells will be placed in exactly the same time-frequency position in all cells in the super-cell, which enable a UE to estimate the composite channel H=H₁+H₂+ . . . H_{M}. PDSCH data mapping follows the same mapping rules as in non-CoMP single-cell system, and are punctured on a resource element if it's occupied by a DRS symbol.

Still further, while numerous examples have thus been provided, one skilled in the art should recognize that various modifications, substitutions, or alterations may be made to the described embodiments while still falling with the inventive scope as defined by the following claims. Other combinations will be readily apparent to one of ordinary skill in the art having access to the instant specification.

What is claimed is:

1. A method of mapping data in a wireless communication system, comprising the steps of:
forming a first frame having plural positions at a first transmitter, the first frame having a first plurality of reference signals;
forming a second frame having plural positions corresponding to the plural positions of the first frame at a second transmitter, the second frame having a second plurality of reference signals;
inserting a plurality of data signals into the first frame at positions that are not occupied by either the first or second plurality of reference signals;
inserting the plurality of data signals into the second frame at positions that are not occupied by either the first or second plurality of reference signals; and
transmitting the first and second frames to a remote receiver.

2. A method as in claim 1, wherein the positions are frequency domain resource element positions.

3. A method as in claim 1, wherein the reference signals are channel-specific reference signals (CRS).

4. A method as in claim 1, wherein the first frame and the second frame each have at least one position having a same time and frequency domain, wherein the at least one position of the first frame includes a reference signal, and wherein the at least one position of the second frame includes a data signal.

5. A method as in claim 1, wherein the first plurality of reference signals and the second plurality of reference signals have the same positions in a time and frequency domain, respectively.

6. A method as in claim 1, wherein the reference signals are dedicated-specific reference signals (DRS).

7. A method as in claim 6, wherein the reference signals in the first frame are the same as the reference signals in the second frame.

8. A method as in claim 6, wherein the reference signals in the first frame occupy the same position in a time and frequency domain as the reference signals in the second frame.

9. A method as in claim 6, wherein the reference signals in the first frame and the reference signals in the second frame are orthogonal and non-colliding in a time and frequency domain.

10. A method of receiving data from remote wireless transmitters in a wireless receiver, comprising the steps of:
receiving a first frame having plural positions by the wireless receiver from a first transmitter, the first frame having a first plurality of reference signals;
receiving a second frame having plural positions corresponding to the plural positions of the first frame by the wireless receiver from a second transmitter, the second frame having a second plurality of reference signals;
receiving a plurality of data signals in the first frame at positions that are not occupied by either the first or second plurality of reference signals; and
receiving the plurality of data signals in the second frame at positions that are not occupied by either the first or second plurality of reference signals.

11. A method as in claim 10, wherein the positions are frequency domain resource element positions.

12. A method as in claim 10, wherein the reference signals are channel-specific reference signals (CRS).

13. A method as in claim 10, wherein the first frame and the second frame each have at least one position having a same time and frequency domain, wherein the at least one position of the first frame includes a reference signal, and wherein the at least one position of the second frame includes a data signal.

14. A method as in claim 10, wherein the first plurality of reference signals and the second plurality of reference signals have the same positions in a time and frequency domain, respectively.

15. A method as in claim 10, wherein the reference signals are dedicated-specific reference signals (DRS).

16. A method as in claim 15, wherein the reference signals in the first frame are the same as the reference signals in the second frame.

17. A method as in claim 15, wherein the reference signals in the first frame occupy the same position in a time and frequency domain as the reference signals in the second frame.

18. A method as in claim 15, wherein the reference signals in the first frame and the reference signals in the second frame are orthogonal and non-colliding in a time and frequency domain.

19. A method of mapping data in a wireless communication system, comprising the steps of:
forming a first frame having plural frequency domain resource elements at a first transmitter, the first frame having a first plurality of control signals
forming a second frame having plural frequency domain resource elements corresponding to the plural frequency domain resource elements of the first frame at a second transmitter, the second frame having a second plurality of control signals;
inserting a first plurality of data signals into the first frame at frequency domain resource elements that are not occupied by either the first or second plurality of control signals;
inserting the first plurality of data signals into the second frame at frequency domain resource elements that are not occupied by either the first or second plurality of control signals; and
transmitting the first and second frames to a remote receiver.

20. A method as in claim 19, wherein the first frame and the second frame each have at least one position having a same time and frequency domain, wherein the at least one position of the first frame includes a reference signal, and wherein the at least one position of the second frame includes a data signal.
